(19) United States
(12) Patent Application Publication
(10) Pub. No.: US 2010/0137763 A1
(43) Pub. Date: Jun. 3, 2010

(54) Neck-massaging device

(76) Inventor: Loren Howard Dorshow, Minnetonka, MN (US)

Correspondence Address: Raghavan Rajagopalan, 204 City Gate Lane, St. Peters, MO, 63303, US

(21) Appl. No.: 12/592,608

(22) Filed: Nov. 30, 2009

Related U.S. Application Data
(60) Provisional application No. 61/200,621, filed on Dec. 1, 2008.

(51) Int. Cl. A61H 7/00

(52) U.S. Cl. 601/134

(57) ABSTRACT

A massaging device for the neck comprising cushion elements, enclosure elements, and sealing means is disclosed.

This application claims priority under previously filed provisional application No. 61/200,621 with the filing date of Dec. 1, 2008.

### FIELD OF THE INVENTION

This invention pertains to the body massaging devices. More particularly, it relates to a device that comprises substantially spherical cushion elements tethered together by a flexible enclosure element.

### BACKGROUND

The massaging of the human body has been used extensively for relieving pains and for providing therapeutic effects. Professional massagers and chiropractors generally use their bare hands when relieving pain, stress, and discomfort. Various auxiliary massaging devices disclosed in the prior art such as vibrators, rolling pins, rotating balls, and the like have been used to augment the beneficial effect of the massage.

Chu [U.S. Pat. No. 4,936,294] discloses a massaging device to be used principally by people who spend considerable time in chair or seat. This device comprises plurality of hemispherical balls uniformly distributed and mounted on a rectangular rigid support measuring about 15×21 inches. The balls are roughly comparable in size and firmness to a tennis ball, and are arranged in closely-spaced parallel rows on said support.

Lohati et al. [U.S. Pat. No. 4,577,625] disclose a rotating ball massaging device for hands. This device comprises plurality of rotating beads tethered together inside an enclosure configured in the form of a flexible mitten. When the mitten is moved back-and-forth, the rotating beads impart a soothing effect to tired and aching muscles. The assemblies are permanently attached to the palm, finger and thumb areas of a glove or mitten, to various shapes of cushions/cushion enclosures, or to a single fabric or a two-ply air filled fabric that is stretched and attached to a rigid frame. The glove and mitten embodiments particularly solve the problems that occur when hand-held loose balls, pebbles and the like as are used to give a massage.

McCauley [U.S. Pat. No. 4,198,962] discloses a foot massager. This device comprises a plurality of rotatable balls mounted on parallel bars, which are supported in a frame suitable for placement on the floor. A detachable electric vibrator is mounted within the frame to impart a vibrating and massaging action to the balls through the frame. The user merely places the foot on massager and moves the foot back-and-forth to have a gentle massaging and vibrating action imparted to the foot.

Collins [U.S. Pat. No. 2,290,407] discloses an osteopathic massaging device for the spine. This device comprises a concave frame to which a series of inflated rubber balls, enclosed by rubber covering, are mounted. This device provides means for laterally flexing the spine of a patient to result in a jaw-like motion. Such a motion is believed to cause membranes to relax and relieve strain in the muscles.

All of the currently known massaging devices are not specifically designed for massaging the neck of an individual, and the devices mentioned above cannot be effectively used for the neck. Accordingly, the object of the present invention is to provide simple, effective device that offers instant relief to tired, aching muscles and nerves of the neck. It is further objective of the invention to provide a neck massager that: can be used by both non-professional persons as well as professional masseurs and therapists; can be easily manipulated by an individual without assistance from another person; can be operated as a single unit or attached to and used in conjunction with electrical vibrators and/or heating elements; and can be easily and inexpensively manufactured.

### SUMMARY OF THE INVENTION

The present invention discloses a neck-massaging apparatus comprising two elements: a cushion element, and an enclosure element. The cushion element comprises substantially spherical, cylindrical, or ellipsoidal object derived from spongy, foamy, or rubbery material with a diameter ranging from about 1 inch to about 4 inches. The enclosure element comprises a flexible pouch that will accommodate a plurality of cushion elements, and is sealed at both ends to restrain said cushion element.

### BRIEF DESCRIPTION OF THE DRAWINGS

FIG. 1a-e. Perspective views of the cushion elements.

FIG. 2a-c. Cross-sectional view of the cushion elements.

FIG. 3a-d. Perspective view of the enclosure element.

FIG. 4a-c. Massaging device—Various configurations of the neck massage device.

### DETAILED DESCRIPTON OF THE INVENTION

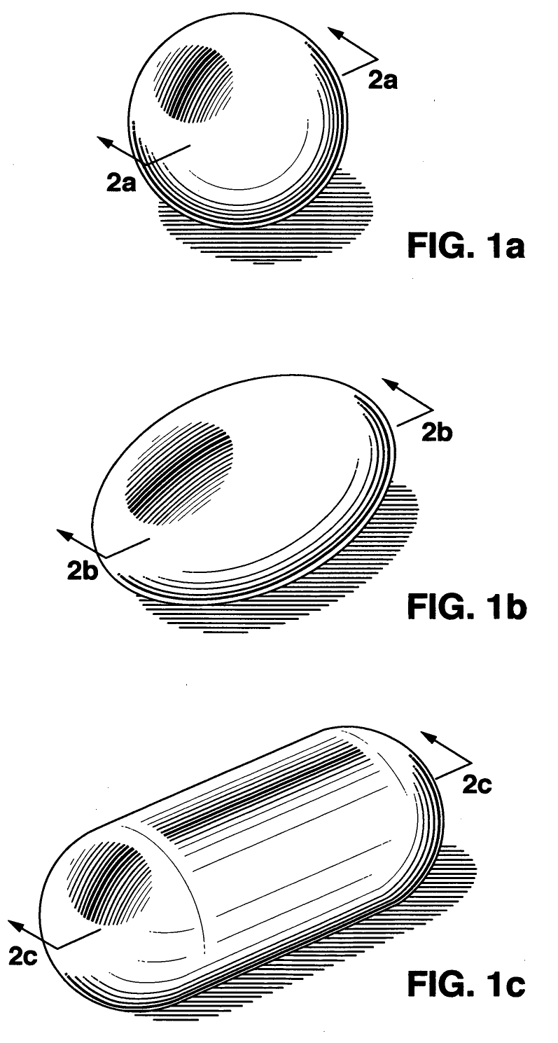

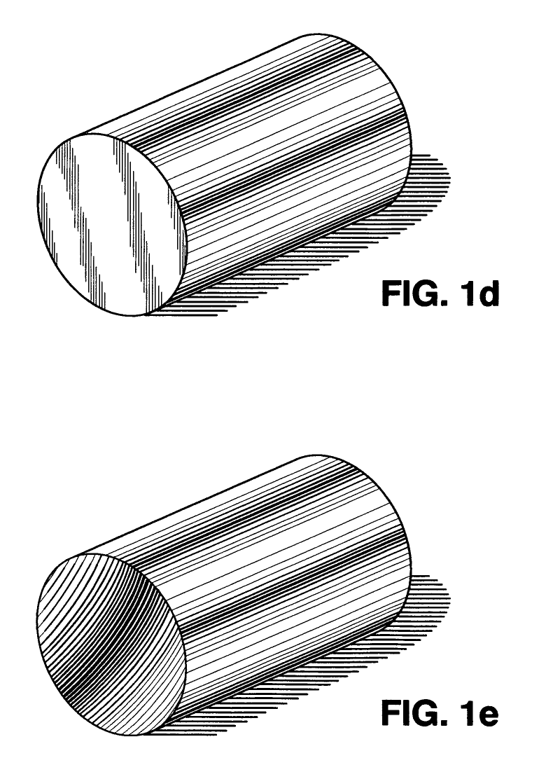

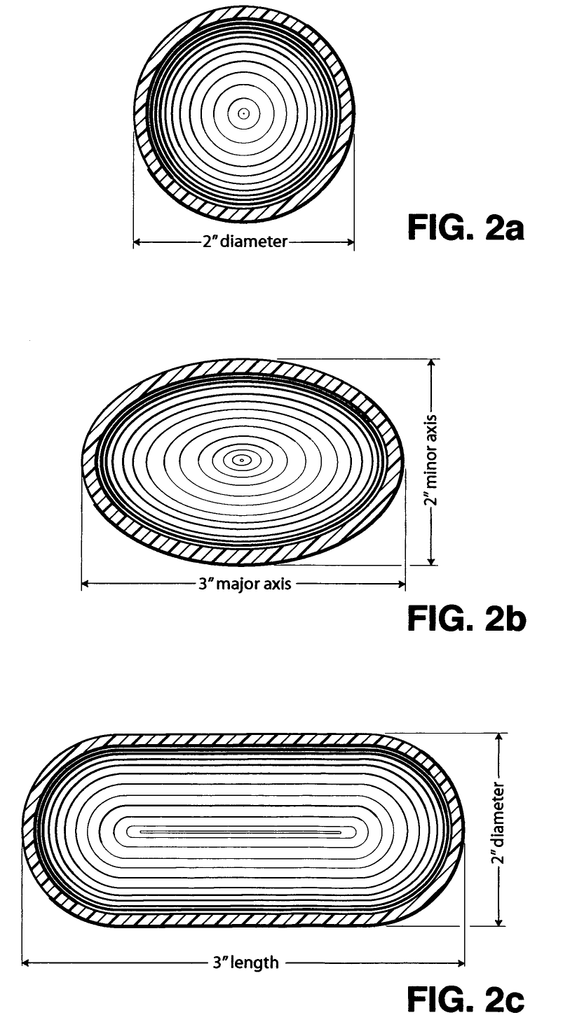

The present invention discloses a neck-massaging apparatus comprising a plurality of cushion elements contained in an enclosure element. The cushion elements are resilient spherical (FIG. 1a), ellipsoidal (FIG. 1b), or cylindrical (FIGS. 1c-e) objects that are formed of elastic material comparable in size and firmness to a tennis ball. The dimensions of the cushion element may vary depending on the individual using the massage device. The sides of the cylindrical cushion element may be flat, concave, or convex. The cushion elements may be hollow in the interior (FIG. 2a-c), or may be solid material that is readily compressible upon application of pressure from the neck or the back, or may be a hollow material filled with a compressible material such as sponge, cotton, and the like. Said elastic material may be derived from natural or synthetic rubber, plastic or other synthetic polymers, cotton, wool, and the like. The number, size, and the type of cushion elements contained in the enclosure element may vary depending on the age, size, and gender of the individual. In one embodiment, the cushion element may be uniform in size and type. For example, the cushion element may all be hollow, spherical rubber ball.

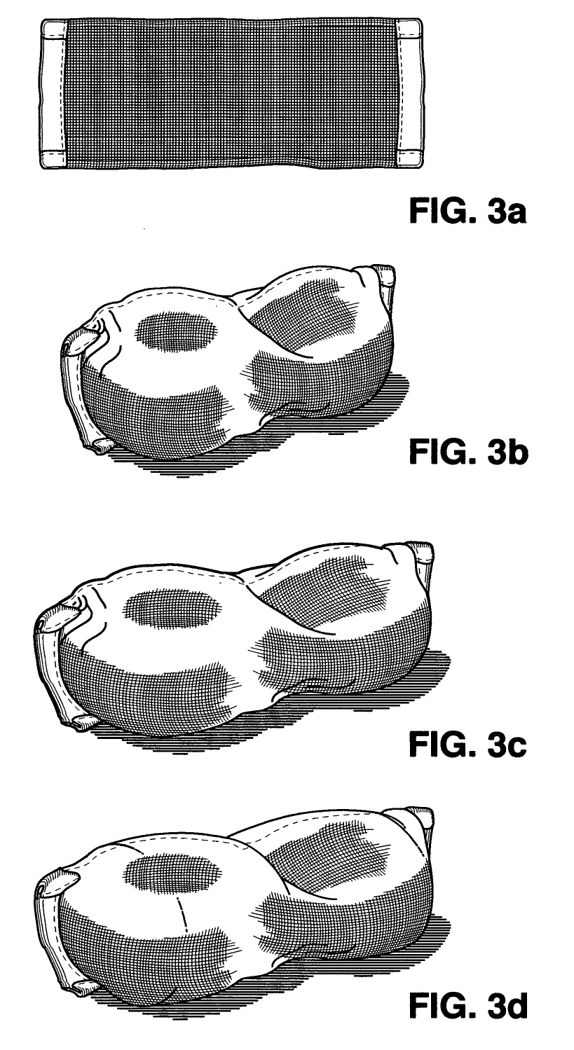

The enclosure element (FIG. 3a) is a thin, flexible, and cylindrically symmetric sleeve capable of securing a plurality of said cushion elements snugly or tightly within said enclosure element (FIGS. 3b-d). The dimensions of said enclosure element are determined by the size and number of the cushion elements. The diameter of the enclosure element is typically equal to or about 5-20% greater than the diameter of the cushion element, and the length of the enclosure element is typically equal to or greater than the sum of the diameter of each cushion element. For example, if three spherical cushion elements each having diameter of about 2 inches are to be used, then the diameter of the enclosure element is at least 6 inches. The fabric for the enclosure element may be derived from natural or synthetic fibers, including, but not limited to cotton, silk, wool, polyester, and the like.

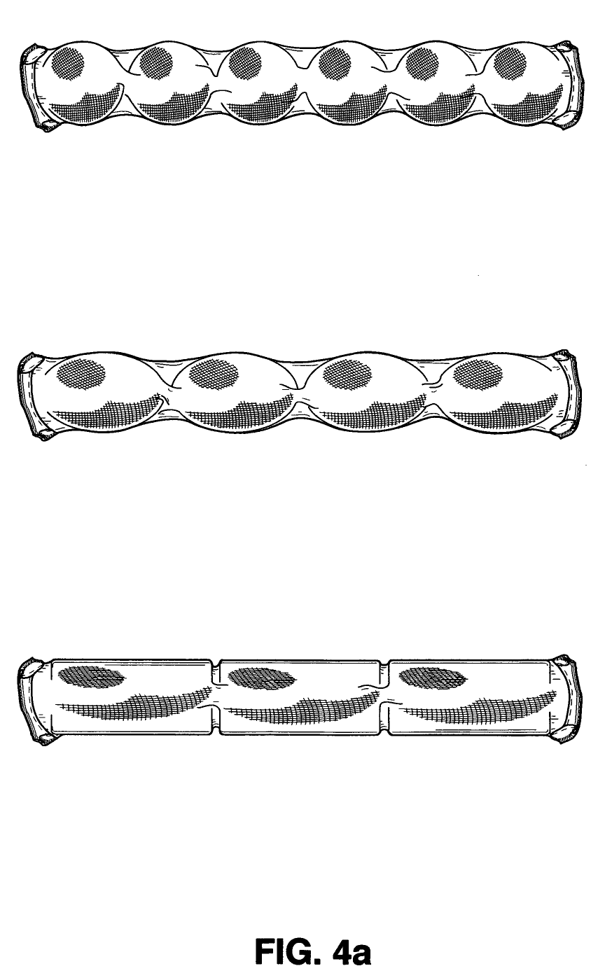

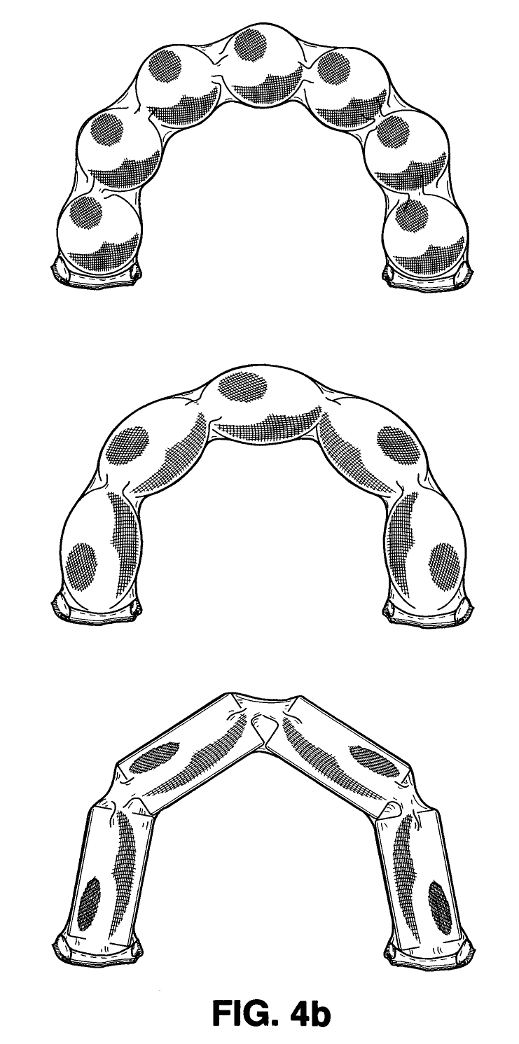

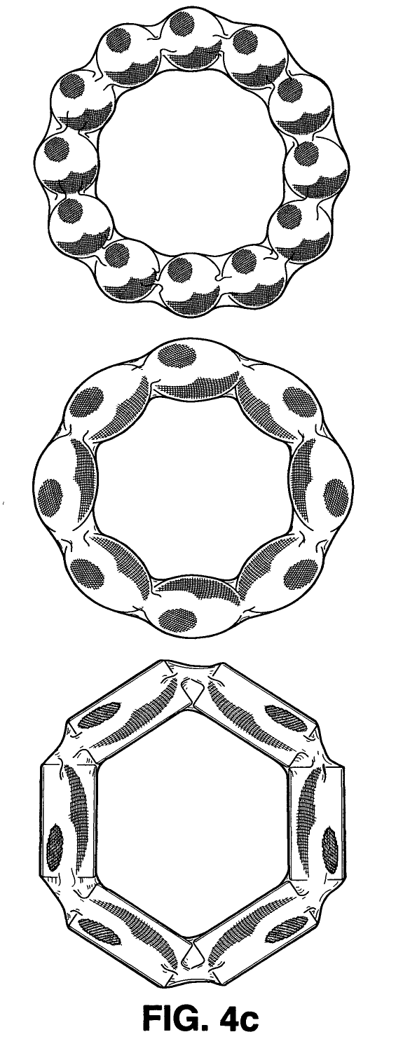

The ends of the enclosure element are sealed by any one of the number of sealing means known in the art. For example, the ends may be sealed using a zipper mechanism, Velcro straps, and the like, or by stitching the ends with needle and thread. The resulting massage device can be configured in various shapes, e.g. linear, semicircular, or torroidal (‘donut-shaped’) as shown in FIG. 4a-c.

The massaging device of the present invention is placed against the back of the neck. When the user presses against the device, the cushion elements provide an irregular surface that engages the neck at spaced points and provides soothing massaging action. The cushion elements may deform in accordance with the amount of pressure applied by the user in order to achieve optimal massaging action. The massaging effect depends to a large extent on the resilience of the cushion elements. Cushion elements that are too rigid would not conform to the configuration of the neck, and those that are too soft will provide little or no massaging action. The device of the present invention is designed for use by any individual experiencing neck pain resulting from stress, sprain, or other injuries.

Certain exemplary aspects of the invention are set forth below. It should be understood that these aspects are presented merely to provide the reader with a brief summary of certain forms the invention might take, and that these aspects are not intended to limit the scope of the invention. Indeed, the invention may encompass a variety of aspects that may not be explicitly set forth below. For example, the cushion elements may be tethered by a string or an adhesive substance prior to their being placed inside the enclosure element. In an effort to provide a concise description of these embodiments, all features of an actual implementation may not be described in the specification. It should be appreciated that in the development of any such actual implementation, numerous implementation-specific decisions must be made to achieve the developer's specific goals, such as compliance with system-related and business-related constraints, which may vary from one implementation to another.

1. A neck-massage device comprising cushion elements, enclosure elements, and sealing means, wherein one or more cushion elements are contained in a sealed enclosure element such that said cushion elements are held snugly or tightly within said enclosure element, and the enclosure element is sealed at both ends with said sealing means.

2. The device according to claim 1, wherein the cushion element is a hollow, compressible spherical material.

3. The device according to claim 1, wherein the cushion element is a solid, compressible spherical material.

4. The device according to claim 1, wherein the cushion element is a hollow spherical material filled with a compressible material.

5. The device according to claim 1, wherein the diameter of the cushion element ranges from 1 to 4 inches.

6. The device according to claim 1, wherein the cushion element is a hollow, compressible ellipsoidal material.

7. The device according to claim 1, wherein the cushion element is a solid, compressible ellipsoidal material.

8. The device according to claim 1, wherein the cushion element is a hollow ellipsoidal material filled with a compressible material.

10. The device according to claim 1, wherein the length of the major axis of the ellipsoid ranges from 1 to 4 inches.

11. (canceled)

12. (canceled)

13. The device according to claim 1, wherein the enclosure element is a fabric composed of natural fibers.

14. The device according to claim 1, wherein the enclosure element is cotton, silk, or wool.

15. The device according to claim 1, wherein the enclosure element is a fabric composed of synthetic fibers.

16. The device according to claim 15, wherein the enclosure element is a polyester.

17. The device according to claim 1, wherein the enclosure element is a fabric composed of a combination of natural and synthetic fibers.

18. The device according to claim 17, wherein the enclosure element is a fabric composed of a combination of polyester and cotton.

19. The device according to claim 1, wherein the sealing means is a zipper.

20. The device according to claim 1, wherein the sealing means is a Velcro strap.

21. The device according to claim 2, wherein the cushion element is a tennis ball.

22. The device according to claim 3, wherein the cushion element is a sponge.

23. The device according to claim 4, wherein the cushion element is hollow rubber ball filled with water.
